(19) United States
(12) Patent Application Publication
(10) Pub. No.: US 2009/0218299 A1
(43) Pub. Date: Sep. 3, 2009

(54) INVERTED AERATED IMMERSED SCREEN, SCREEN ASSEMBLY AND OPERATING PROCESS

(76) Inventors: Pierre Lucien Cote, Dundas (CA); Jennifer Lynn Pawloski, Guelph (CA); Michael David Theodoulou, Milton (CA); Stanford Chuk-Wah Li, Mississauga (CA); Douglas Joseph Thompson, Hamilton (CA); Ali Adnan, Hamilton (CA)

Correspondence Address: BERESKIN & PARR (MISSISSAUGA) / GE, SCOTIA PLAZA, 40 KING STREET WEST, 40TH FLOOR, TORONTO, ON, M6H-3V2, CA

(21) Appl. No.: 12/299,096

(22) PCT Filed: May 4, 2007
(86) PCT No.: PCT/US2007/068207

§ 371 Date: Apr. 24, 2009

Related U.S. Application Data
(60) Provisional application No. 60/797,773, filed on May 5, 2006.
(60) Provisional application No. 60/798,294, filed on May 8, 2006.
(60) Provisional application No. 60/876,134, filed on Dec. 21, 2006.

(51) Int. Cl. B01D 61/16; C02F 1/44; B01D 61/18; B01D 65/00; B01D 65/08; B01D 39/10

(52) U.S. Cl. 210/791; 210/499; 210/259; 210/407; 210/435; 210/198.1; 210/195.2; 210/209; 210/257.2; 210/488; 210/248

(57) ABSTRACT

A static screen used upstream of a membrane assembly within a water treatment system has a screening surface with a number of openings distributed over its area. Liquid flows through the screening surface to reach the membrane assembly. Various shapes of screening surfaces are described including three-dimensional bodies with openings at or near their lower ends. Methods for cleaning the screen are described including aeration, backwashing and lowering down the water level in an upstream section by partially or completely draining a tank. Various treatment systems or process designs incorporating the screen are described. Screen elements may be made in two or more parts comprising a supporting structure and a separation layer and may be mounted on a conduit or pan.

For the U.S.A., this is an application claiming the benefit under 35 USC 119(e) of U.S. Ser. No. 60/797,773 filed May 5, 2006; U.S. Ser. No. 60/798,294 filed May 8, 2006; and U.S. Ser. No. 60/876,134 filed Dec. 21, 2006. All of the applications above are incorporated herein, in their entirety, by this reference to them.

### FIELD

This invention relates to an immersed or static screen, to a method of making an immersed or static screen, to a process of operating or cleaning a screen and to a water treatment apparatus or process using screens, for example a water treatment apparatus or process using membranes.

### BACKGROUND

The following description of background is not an admission that anything discussed in the description is citable as prior art or part of the knowledge of persons skilled in the art in any country.

Some water treatment systems include a number of membrane assemblies that may contain a number of membrane fibers or sheets. The membrane fibers or sheets are held in place, typically through one or more headers or frames, within a larger assembly which may be called an element, module or cassette. The membrane fibers or sheets can be damaged by trash, roped hair or other fibrous materials that may become entangled with or around the membrane fiber or sheet. Moreover, trash, hair or fibrous materials are difficult to remove from membranes.

Reducing the build-up and entanglement of trash, hair or fibrous materials within membrane assemblies is desirable for efficient operation and longevity of a water treatment system.

One process for reducing the build-up of hair, trash or fibrous materials includes pre-screening a raw feed stream before it enters a membrane bioreactor. However, pre-screening the feed stream is typically only effective in reducing the concentrations of trash or fibrous materials that are roped or balled together in the feed. Pre-screening the raw sewage stream does not adequately remove individual strands or small bundles of trash or fibrous materials that can later come together to form relatively thick roped lengths or balled bundles inside the waste water treatment system. That is, a pre-screening filter permits individual strands of hair, for example, to easily pass into a water treatment system. Once inside the water treatment system the individual hairs are prone to roping and balling together. The roped hairs become entangled with the membrane fibers causing wear and damage. Additionally, recontamination of the pre-screened water is common since the water may pass through open tanks included in many water treatment facilities. Debris such as leaves from nearby trees or other contaminates brought by the wind frequently blows into the tanks. Further, the mechanical design of screens themselves may make them expensive or difficult to install or operate, particularly at high flows and fine mesh sizes.

U.S. Pat. No. 6,814,868 describes a process for reducing a trash or fibrous materials concentration in a wastewater treatment system having a membrane filter in conjunction with a bioreactor. The process comprises flowing a portion of mixed liquor through a screen in a side stream. The flow rate of the mixed liquor through the screen is about no more than the average design flow rate of the wastewater treatment system. The screenings can be either treated or disposed of directly or in combination with the waste activated sludge. The openings of the screen are between about 0.10 mm and about 1.0 mm in size as can be provided by, for example, a rotary drum screen.

U.S. patent application Ser. No. 11/168,405 filed on Jun. 29, 2005, and published as US Publication No. 2006-0008865 describes, among other things, a number of possible configurations for a static or immersed screen and a method of cleaning such a screen which involves inducing a backwash through the screen, for example by aerating an upstream section of the screen. US Publication No. 2006-0008865 is incorporated herein, in its entirety, by this reference to it.

### SUMMARY

The following summary is intended to introduce the reader to the invention but not to limit or define any claimed invention. Inventions may reside in a combination or sub-combinations of the apparatus elements or process steps described below or in other parts of this document. The inventors do not waive or disclaim their rights to any other invention or inventions disclosed in this specification merely by not describing such invention or inventions in the claims.

A screening apparatus for use in a water treatment system may have an upstream area under ambient pressure with a first static head and a downstream area under ambient pressure with a second static head. The screening apparatus may comprise:

one or more generally static screening surfaces in the form of a three-dimensional figure with a discharge port near the bottom of the figure;
a structure for holding the screening surface in communication with the upstream and downstream areas such that the screening surface intercepts water flowing between the upstream and downstream areas; and,
one or more aerators in communication with the upstream area.

An apparatus may comprise:
one or more fluidly connected tanks;
an inlet to the one or more tanks;
a membrane assembly immersed in one of the tanks;
a static screen in the form of an open-bottomed three-dimensional figure separating a volume of water containing the membrane assembly from the inlet;
a permeate outlet connected to the membrane assembly; and,
a membrane retentate outlet in communication with the volume of water containing the membrane assembly.

A screening surface may be in the shape of a three-dimensional figure, for example a cylinder having an opening near its bottom. The opening may be, for example, an open bottom of the figure or a port in another surface near the bottom of the figure. The opening may be fluidly connected to one or more conduits, for example pans or pipes, which may be fluidly connected to a downstream area, for example a membrane tank or zone. One or more of the three-dimensional figures may be held in a frame. The frame may also hold aerators. The frame may have guardrails or other restraining elements to constrain the movement of uppers ends of the screening surfaces. The screening surface may have an area that is twice the cross-sectional area of the screening apparatus or more. The screening surface may be cleaned without the use of moving mechanical parts acting directly on the screening surface. A static screen may have a screening surface and a non-porous surface.

An upstream aerator may provide air scouring of a screening surface during forward operation or cause a backwash of the screening surface during a cleaning or deconcentration procedure. The screening apparatus may further have an overflow weir or drain upstream of the screening surface for removing solids retained by the screen, for example during deconcentration or cleaning procedures. Solids retained by the screen in an upstream area may be sent to a waste stream or re-cycle to other parts of the system. Some of these elements may be combined. For example, an aerator may simultaneously scour the screening surface with bubbles, float screenings in the upstream area to an overflow to assist in their removal or recycle, and cause a backwash of the screen.

A two-part screen assembly may provide a high SSAᵣₐₜᵢₒ (ratio of total screen surface area of one or more screen assemblies to the area of a vertical cross-section of a tank holding the screen assemblies), for example 5 or more or 10 or more. The screen assembly may be generally in the shape of an elongated three-dimensional body, for example having a height of five times or more than the diameter of a circle having the same area as its base. The screen assembly may also have an internal passage, the cross-sectional periphery of which is mostly, or generally, surrounded by a separating layer. The screen element may comprise a supporting structure and a separation layer. The screen assembly may be prismatic, for example tubular. The screen assembly may be connected to a collector, for example a pan or a conduit. The collector may be in communication with a downstream container. Water being filtered may flow through the separating layer to the internal passage, then flow through the internal passage to the collector and then to the downstream container.

A method for cleaning an immersed static screen may involve lowering down the water level in a section upstream of the screening surface by partially or completely draining the upstream section. The upstream section may be drained through a weir set at a height near the minimum water level in a membrane tank downstream of the screening surface. The drained water may be returned to an upstream process tank. Flow from a process tank upstream of the upstream section of the screen may be inhibited or stopped while the upstream section of the screen is drained.

One or more other apparatuses or processes may be provided by combining any one or more apparatus elements or process steps selected from the set of all apparatus elements and process steps described in this summary or in other parts of this document.

### BRIEF DESCRIPTION OF THE DRAWINGS

FIG. 1 is a schematic plan view diagram illustrating a waste water treatment system;

FIG. 2A is a schematic diagram illustrating a side view of a membrane tank shown in FIG. 1A;

FIG. 2B is a schematic plan view of an alternate membrane tank.

FIG. 2C is a schematic side view of a further alternate membrane tank and wastewater treatment system with a screening apparatus.

FIG. 3A is a schematic isometric drawing of another screening apparatus with screening elements removed;

FIG. 3B is an isometric cross-section of FIG. 3A with screening elements attached;

FIG. 4 is a schematic side view of a screening apparatus.

FIG. 5 is a schematic representation of static screens of various configurations.

FIG. 6 is a photograph showing examples of rigid tube used as inner part of a cylindrical screen assembly.

FIG. 7 is a schematic diagram showing an example of a 2-part cylindrical screen assembly.

FIG. 8 is a schematic diagram of a vessel containing a static screen and immersed membranes.

FIG. 9a is a schematic diagram of HSM collectors with screen assemblies.

FIG. 9b is a schematic diagram of a flat pan collector.

FIG. 9c shows a U-pan collector.

FIG. 10 is a schematic diagram of an immersed screen installation based on the HSM conduits.

FIG. 11 is a schematic diagram of an immersed installation based in a pan (U-pan or flat pan).

FIGS. 12a and 12b are schematic diagrams of MBR configurations.

FIG. 13 is a schematic plan view diagram of an MBR layout with sump.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors and owners reserve all rights in any invention disclosed in an apparatus or process described below that is not claimed in this document and do not abandon, disclaim or dedicate to the public any such invention by its disclosure in this document.

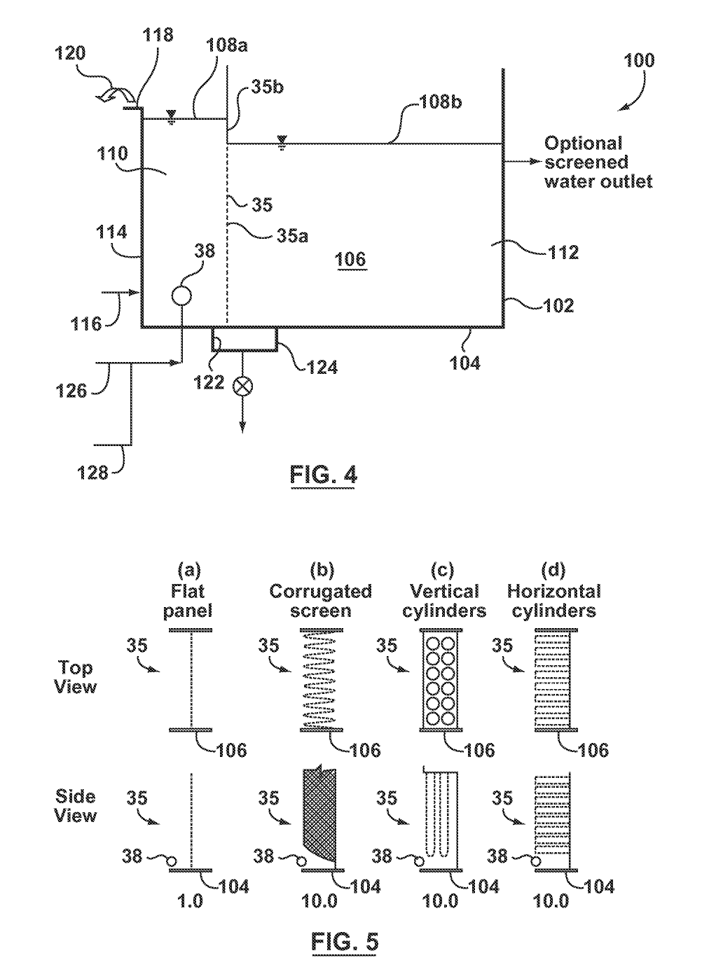

FIG. 4 shows a screening apparatus 100 having a static screen 35 mounted in a vessel 102. The vessel 102 may be, for example, a tank, trough, channel or other conduit or holding means for water. The vessel 102 has a bottom 104 and a pair of opposed sides 106, the closer of the two opposed sides 106 not shown, defining a pathway for water to flow through the vessel 102 by generally open channel flow. The sides 106 may be curved, as in a round tank. The static screen 35 spans between the opposed sides 106 either directly or by spanning between partitions or other non-porous elements attached to the sides 106. The static screen 35 also extends from the bottom 104 of the vessel to above a surface level 108 of the water in the vessel 102, either directly or by extending between non-porous elements attached to the bottom 104 or across a higher elevation of the vessel 102. In particular, the static screen 35 may have a screening surface 35a and a non-porous surface 35b. Water passing through the pathway, or from one end of the vessel 102 to another, is made to pass through the static screen 35, particularly the screening surface 35a. In this way, the static screen 35 separates the vessel 102 into an upstream section 110 and a downstream section 112. Either the upstream section 110, the downstream section 112 or both may be shared with other elements of a water treatment system. For example, the downstream section 112 may function as a membrane tank.

The non-porous surface 35b may extend from below the downstream water level 108b to above the upstream water level 108a. The non-porous surface 35b may cover between about 5% to 25% of the height of the static screen 35. The non-porous surface 35b serves to prevent water in the upstream section 110 above the water level 108b in the downstream section 112 from flowing to the downstream section 112. This assists in creating an airlift in the upstream section 110 when the upstream section 110 is aerated and is believed to improve the effectiveness of the backwash, particularly in upper parts of the static screen 35. In the absence of a distinct non-porous surface 35b, trash or other solids etc. may accumulate on an upper section of the screening surface 35a and eventually act as a non-porous section 35b. It is not necessary to use moving mechanical parts in contact with the screening surface 35a to clean the static screen 35.

During forward operation, a difference in static head between the water level 108a in the upstream section 110 and the water level 108b in the downstream section 112 drives the flow of water through the static screen 35. This head difference may be low, for example 30 cm or less, or between 15 and 30 cm. The water level 108 may be generally in the range of 2 to 4 metres.

The screening apparatus 100 may have an upstream barrier 114 which may be a partition or, as shown, an end wall of the vessel 102. The barrier 114 and the most downstream surface of the screen 35 may be located near each other, for example between 15 cm and 2 m apart, such that the upstream section 110 may have a relatively small volume compared to the downstream section 112. For example, the upstream section 110 may have a volume that is 30% or less than the volume of the downstream section 112. Particularly where the downstream section 112 contains membrane assemblies, the upstream section 110 may have a volume between about 2% to 20%, for example about 10%, of the volume of the downstream section 112. The specific size of upstream and downstream sections 110, 112, or their relative volumes, may be designed by noting that if all flow to the membrane assemblies pass through the static screen 35, then the flow to the membranes (in m³/d) is equal to (a) the product of screen specific surface area (m² screening surface 35a per m³ upstream section 110 volume), the screen flux (m/d) and the volume of the upstream section (m³) which is in turn equal to (b) the membrane specific surface area (m² membrane surface area per m³ volume of the downstream section 112) the membrane flux (m/d) and the volume of the downstream section 112. Membrane specific surface areas and fluxes may range from, for example, about 50-400 m²/m³ and 0.5-2.0 m/d respectively. Screen specific surface area may range from, for example, about 3-30 m²/m³, or be typically about 10 m²/m³, and screen flux may range from about 50-200 m/d, with a typical value about 100 m/d. Alternately, or additionally, the dimensions of the upstream and downstream sections 110, 112 may be designed noting that between about 15 and 150%, for example 20-70%, of the volume of the upstream section 110 may flow through the static screen 35 from the downstream section 112 during a backwash, to be described below. This flow should not decrease the water level 108b in the downstream section 112 excessively, for example by not more than about 20 cm or 10 cm or 7% of the ordinary water level 108b of the downstream section 112.

An inlet 116, which may be, for example, a pipe or hole or space below a partition, allows influent water or feed to enter the upstream section 110, for example from near the bottom of the upstream section 110. An overflow 118, which may be a low wall, weir, pipe, channel, or other feature, may allow water containing retained screenings, which may form a waste, reject or recycle stream 120, to leave the upstream section 110 other than by passing through the static screen 35 when the water level 108a in the upstream section 110 rises to above the bottom of the overflow 118. Primary 122 and secondary 124 drains may allow the upstream section 110 and downstream section 112, respectively, to be drained. The drains 122, 124 may be valved collectively, as shown, or individually to allow the drains 122, 124 to be opened separately. An aerator 38, for example a coarse bubble aerator, may be located in the upstream section 110, for example near the bottom 104 of the vessel 102 and near the static screen 35. The aerator 38 may be fed at different times by a filtration gas flow 126 or a backwash gas flow 128 or both. The gas flows 126, 128 may come from a single source, for example a variable speed blower, multiple independently controlled blowers, or flow control valves connected to a source of pressurized air. The filtration gas flow 126 may be in the range of between no flow and one half of the rate of the backwash gas flow 128.

The screening apparatus 100 may operate in repeated cycles of screening and backwashing. The screening may be dead end screening, that is with a volume of water generally equal to the volume of water entering the upstream section 110 passing through the static screen 35 during a filtration period. Alternately, there may be a flow of reject 120 during some or all of a filtration period, either over the overflow 118, through the primary drain 122 or through another outlet, but with water continuing to flow to the downstream section 112 through the static screen 35. The filtration gas flow 126 may be provided continuously or intermittently at a low level during filtration to decrease the rate of reject build up on the static screen 35 while still permitting water to flow forward, that is towards the downstream section 112, through the static screen 35. As rejected materials build up on the static screen 35, the head difference between the water levels 108a, 108b will increase if a constant flow through the static screen 35 is maintained, or flow through the static screen 35 will decrease. In either case, performance may be fully or partially restored by backwashing the static screen 35. Backwashing can be, for example, at fixed intervals, for example as controlled by a timer, or triggered by reaching a preset water level 108a in the upstream section 110, or a decline in flow or another parameter.

The required backwash frequency is related to screen loading rates, trash tolerance, screen surface area and upstream section 110 volume. For example, a pilot system had a screen surface area of 5.4 ft² operating at a screen loading rate of 5.5 gpm/ft² which allowed for a trash tolerance of 3 g/L. The volume of the upstream section 110 was 75 L. The feed flow was 30 gpm (5.5 gpm/ft2×5.4 ft2) and the maximum allowed trash accumulation in the upstream area 110 was 225 g (3 g/L×75 L). With dead end screening, and a trash concentration of 150 mg/L in the feed 116, and assuming complete rejection of trash by the static screen 35, the maximum trash loading is reached in about 13 minutes, requiring backwashing every 13 minutes. Backwashing frequency may vary between 2 and 60 minutes or between 5 and 30 minutes.

Backwashing may be performed, for example, by applying the backwashing gas flow 128 to the aerator 38. The backwashing gas flow 128 may reduce the density in the water in the upstream section 110, floats solids, creates an air lift or performs a combination of two or more of these effects. For example, applying air at a rate of between 2 and 10 scfm into a 67.5 L upstream section 110 produced air to liquid rates of 3 to 20% in the water in the upstream section 110 and approximately corresponding reductions in the density of the fluid on the upstream section. The air to liquid ratio varied generally linearly with air flow rate. The backwashing gas flow 128 causes a flow reversal through the screen 35. During the flow reversal, water is removed from the upstream section 110, for example through primary drain 122 or by increase of the water level 108a in the upstream section 110 above the overflow 118, or further increase of upstream water level 108a above the overflow 118 if the water level 108a was previously above the overflow 118, to remove accumulated solids entrained in the backwash flow. At the end of a period of forward screening, the driving head may have increased to 10 to 30 cm of water column. The backwashing gas flow 128 rate may be such that the air hold-up, or the amount of air trapped in the liquid column, reduces the density of the mixture such that the static head in the upstream section 110 is below that of the downstream section 112. The backwashing gas flow 128 may be in the range of 10-50 scfm/ft² of footprint, or plan view area, of the upstream section 110. Backwash periods may last between 5 and 60 or 10 and 20 seconds. During a backwash, water entering the inlet 116 may continue to flow to, but by-pass, the static screen 35 and assist in recovering retained or rejected solids from the upstream section 110. Alternately, feed flow through the inlet 116 may be stopped during a backwash. For example, feed flow through the inlet 116 during a backwash may be between 0% and 100% or between 10% and 100% of the volume of the upstream section 110. Thus, considering feed flow and backwash flow from the downstream section 112, between 25% and 250% or between 40% to 150% of the volume of the upstream section 110 may be discharged during a backwash.

Rates of gas flows 126, 128 and allowable head through the static screen 35 are related so as to allow both forward filtration and backwashing. For example, maximum head differential, overflow 118 elevation, downstream water level 108b, and backwash gas flow 128 are related in that backwash gas flow 128, in combination with other conditions, must be sufficient to cause a backwash, with water in upstream section 110 at the overflow 118 if aeration and an overflow 118 are the method of water removal during backwash. In contrast, filtration gas flow 126 is made high enough to scour the static screen 35 and prevent quick plugging, but not so high as to reduce the effective head unnecessarily or excessively given a desired range of head differential between upstream and downstream areas 110, 112 during forward screening, overflow elevation 118 or downstream water level 108b constraints.

If the vessel 102 contains membrane assemblies in the downstream section 112, relaxing the membrane assemblies, that is reducing the rate of permeation, or stopping permeation, may be done to reduce the reduction in downstream water level 108b caused by permeation during a screen backwash. Further, backwashing the membrane assemblies may be done during a screen backwash to add water to the downstream section 112 and may temporarily raise the water level 108b in the downstream section 122. In some systems, and optionally with feed 116 to the upstream section 110 temporarily stopped, backwashing the membrane assemblies can cause a backwash of the static screen 35 alone or assist in keeping the water level 108b in the downstream section 112 high during a backwash. To use this effect, a controller controlling the screen backwash process, for example by controlling when the backwash gas flow 128, may communicate with a controller controlling the membrane permeation or backwash processes such that screen backwashing and membrane relaxation or backwashing occur wholly or partially sequentially, simultaneously or generally near each other in time, for example with the membrane backwash or relaxation starting slightly before or with the screen 35 backwash. In this case, the screen 35 backwash frequency may match a fraction or multiple of a membrane backwash or relaxation frequency. Parameters, such as screen opening size, screen loading rate, upstream section recirculation flow, screen aeration rate during filtration, fixed solids loading, etc. may be adjusted to make an even fraction or multiple of the membrane backwash or relaxation frequency acceptable as the screen backwash frequency.

The screening apparatus 100 is useful, among other things, for combination with a membrane water treatment system. The screening apparatus 100 protects downstream membranes. The screening apparatus 100 may be placed directly in front of the membranes to protect them from contamination in upstream parts of the treatment system, for example by placing membrane assemblies in the downstream section 112. In addition to protecting the membranes, the screening apparatus 100 may allow the membranes to be packed at a higher density or operated at increased flux or reduced cleaning or aeration. The screening assembly 100 may replace, remove or reduce the need for head works screening. The static screen 35 may have openings of 3 mm or less. Round or square openings are preferred although other shapes may also be used.

Opening size of punched holes is taken as the diameter of round holes or the smallest width of the opening of holes that are not circular. Opening size of an opening in a mesh is taken as the width between edges of the mesh fibers if using a square mesh, or across the shortest width if the openings are rectangular. Non-round punched holes or rectangular mesh openings preferably do not have a width of opening in any direction more than 5 times, or more than 2 times, the smallest width of opening.

For the purposes of this document, the word “trash” refers to solid particles of 1 mm or more in any dimension. However, a screening apparatus 100 may also protect membranes from other undesirable solids. The words “undesirable solids” refer in this document to any solid having any dimension of 20 μm or more. Trash and undesirable solids may be originally present in the feed water, be introduced into a water treatment system after its inlet or form in the water treatment system by combination of smaller particles. Trash may include roped or balled hair, bits of plastic, vegetation debris, or other solids. Undesirable solids may include sand particles, eggs, or other solids. In general, trash tends to be more damaging to membranes than other undesirable solids. An opening size of 3 mm or less may offer significant protection against trash. Further, the inventors have observed that solids smaller than the opening size may still be caught by a static screen. However, a smaller opening size may help operation with backwash and air scouring as the only cleaning operations. For example, openings of 1 mm or less may avoid stapling with feeds containing hair or short fibres and so reduce cleaning and maintenance needs of the static screens 35. But, much smaller openings may be difficult to clean and provide unnecessary removal of solids. For example, in the context of a membrane bioreactor where mixed liquor is screened, an opening size of 1 mm or less removes significant amounts of hair, even though the hair has a diameter of much less than 1 mm. However, an opening size of 0.5 mm or less will also remove significant amounts of paper fibers although paper fibers appear to readily pass through larger openings. The paper fibers are much less damaging than hair and may also biodegrade in the system. There may be an insufficient protection advantage to justify the increased screen head loss and maintenance of a screen surface 35b with openings of 0.5 mm or less caused by retention of paper fibers. For these reasons, the inventors prefer opening sizes of between 0.5 and 1 mm for screening mixed liquor. However, when screening surface water, for example, the solids loading is lower and biodegradation of undesirable solids does not occur and so smaller opening sizes may be used. For example, opening sizes of 250 μm or less or 100 μm or less provide enhanced protection with acceptable screen head loss and maintenance. Even smaller openings, for example 50 μm or less, or between 20 μm and 50 μm, may advantageously also remove algae or other such items and so offer increased membrane or system performance sufficient to justify further increases in screen head loss and maintenance.

The backwash or reject stream water is a diluted suspension of rejected materials and may be sent to an upstream process tank or a side stream or branch process, for example a backwash water collection tank, a clarifier, a hydrocyclone, or directly to waste. The downstream section 112 is preferably of sufficient volume such that the backwashing lowers the water level 108b on the downstream sections by only a fraction, for example ½ or less, of the maximum head differential through the static screen 35, for example by about 15 cm or less or about 10 cm or less. The backwash gas flow 128 requires a fairly large flow for a short period of time and may be provided by diverting air from an existing source or a source with other uses, for example membrane scouring air or aerobic tank air.

The attributes of the screening apparatus 100 make it ideal for the protection of membranes by continuously screening mixed liquor which will be the primary application described below. However, the screening assembly 100 may also be used for other applications. Such other applications include screening raw sewage, particularly in shipboard applications where there is a low loading rate and tankage to store feed and filtered water, or other small waste water treatment systems. The screening apparatus 100 may also be used to protect membranes filtering surface or other water to create potable or process water or performing tertiary filtration. In this case, smaller openings in the static screen 35, for example 250 microns or less or 100 microns or less, may be used to remove undesirable particles such as sand, Barnacle eggs etc. The screening assembly 100 can also be used to remove algae or floc in surface water or enhanced coagulation filtration applications. In these cases, openings in the static screen 35 may be 50 microns or less and the screening assembly 100 may provide an active separation step.

The static screen 35 may be made in a variety of shapes or configurations, for example as shown in FIG. 5. Design (a) is a simple flat screen laid across a section of a vessel 102 with proper reinforcement. Designs (b), (c) and (d) aim at increasing the screening surface area for a given cross-sectional area of the static screen 35 or a tank that the static screen 35 fits into, as defined by a “Specific Surface Area” parameter:

$${SSA}_{ratio} = \frac{Screening surface area}{Tank cross - sectional area}$$

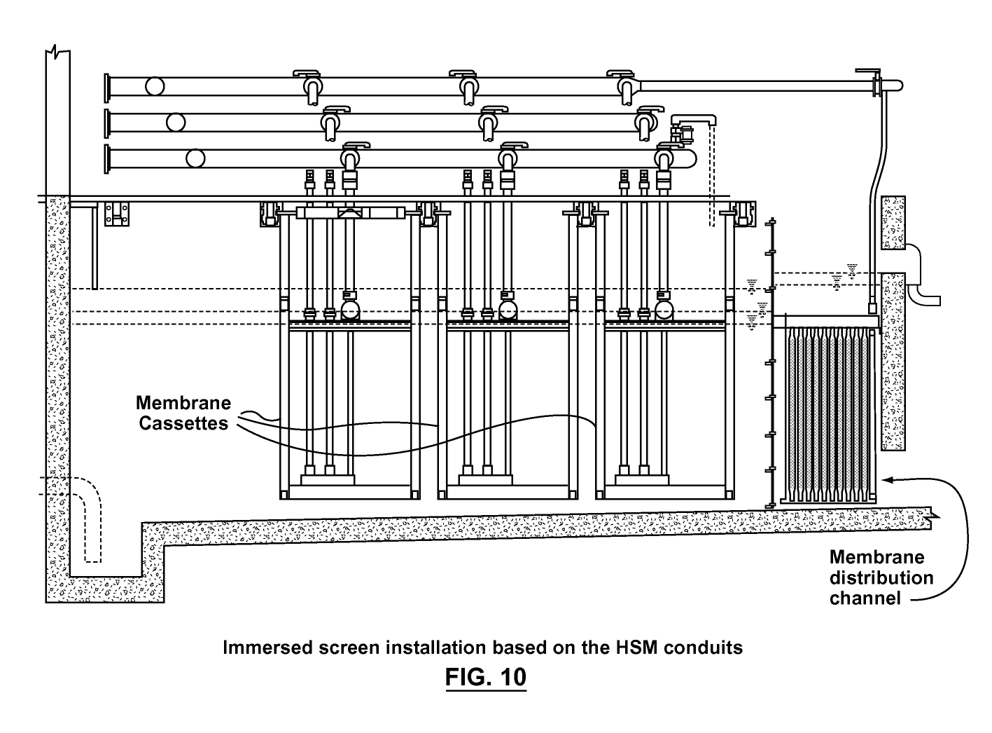

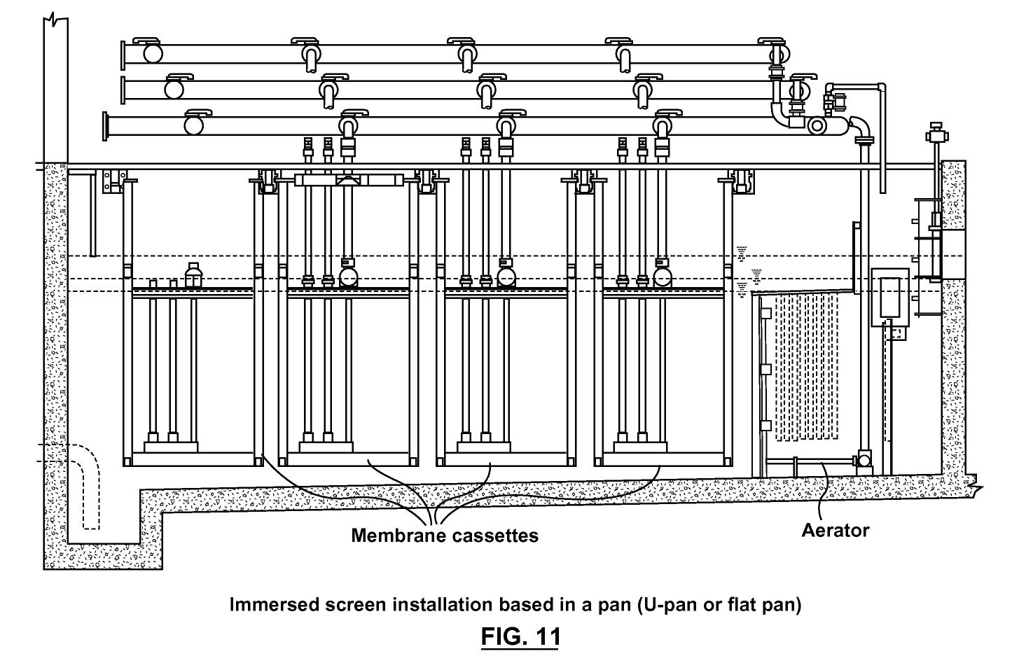

SSAᵣₐₜᵢₒ may be about 1 in situations where a simple screen is sufficient. In more demanding applications, static screens with SSAᵣₐₜᵢₒ of 2 or more, 5 or more or 10 or more, for example between 2 and 15, may be used. Sample designs and screen areas for each of the four designs of FIG. 10 are presented in Table 1. It was assumed for this Table that the screens would be located across the front of a standard tank specified for ZeeWeed™ 500d modules by their manufacturer Zenon Environmental Inc. these tanks have a width of 3 m (10 ft) and operate at a water depth of about 2.75 m (9 ft). To simplify comparison, the 3 non-flat screens have been designed to the same SSAᵣₐₜᵢₒ of 9. Larger screening surface areas could be provided at the same SSAᵣₐₜᵢₒ by locating the static screen along the side of the tank rather than across the front of it.

TABLE 1

| | | Surface Area | |
|---|---|---|---|
| Screen Concept | Key Dimensions | m² (ft²) | SSAᵣₐₜᵢₒ |
| Flat screen (a) | Tank width: 3 m | 7.4 (80) | 0.9 |
| | Water depth: 2.75 m | | |
| | Screen fraction: 0.9 | | |
| Corrugated | Corrugation depth: 300 mm | 74 (800) | 9 |
| screen (b) | Corrugation pitch c/c: 50 mm | | |
| | # of corrugations: 60 | | |
| | Screen height: 2.3 m | | |
| | Screen fraction: 0.9 | | |
| Vertical cylinders | Cylinder diameter: 100 mm | 74 (800) | 9 |
| screen (c) | Cylinder length: 2.0 m | | |
| | # of cylinders: 117 | | |
| | c/c spacing: 125 mm | | |
| | Top plate dimensions: 0.6 m × | | |
| | 3.0 m | | |
| Horizontal | Cylinder diameter: 60 mm | 74 (800) | 9 |
| cylinders | Cylinder length: 0.5 m | | |
| screen (d) | # of cylinders: 785 | | |
| | c/c spacing: 100 mm | | |

Flat or corrugated screens may be made, for example, of wire, plastic or textile fibers, woven or welded into a mesh or fabric, or perforated plates. Cylindrical screens may also be made of, for example, wire mesh, plastic mesh or punched or molded parts. Other materials and structures may also be used.

Tests on a flat screen, as in design (a) of FIG. 10, with 0.75 mm openings, indicate that such a static screen can handle 3-6 gpm/ft², depending on cleaning frequency, trash concentration and whether there is a recirculation flow, for example of about 1 Q through the upstream section 110. Such a recirculation flow, which may flow across the face of the static screen 35 and exit through the overflow 118 or another outlet, has been found to increase acceptable loading rates by 1.5 to 2.5 gpm/ft². With a 10 ft wide tank and 9 ft water depth, and providing 3″ for structural support on all 4 sides, the flat panel static screen 35 has an area of about 80 square feet. Such a screen is suitable for applications having up to about 2 Q of flow with a tank holding a cassette 48-64 ZeeWeed™ 500 membrane elements or flows of 1 Q with two such cassettes. Suitable applications could include filtration plants, small sewage systems, or shipboard or military wastewater systems. Changing to a corrugated static screen 35 allows a higher flow or more membrane elements to be placed in the tank. For example, a corrugated static screen 35 may have a depth of 300 m, pitch of about 60 mm, height of 2.6 m, and 50 loops for a total area of about 78 m² or 845 ft². Such a screen would allow flows of 3-6 Q to be provided to tanks containing about 192 to 384 elements of ZeeWeed™ 500 membranes, or 3 to 8 cassettes, with flows through the static screen 35 of 5 gpm/ft² or less. Such a static screen 35 would be suitable, for example, for larger wastewater treatment systems.

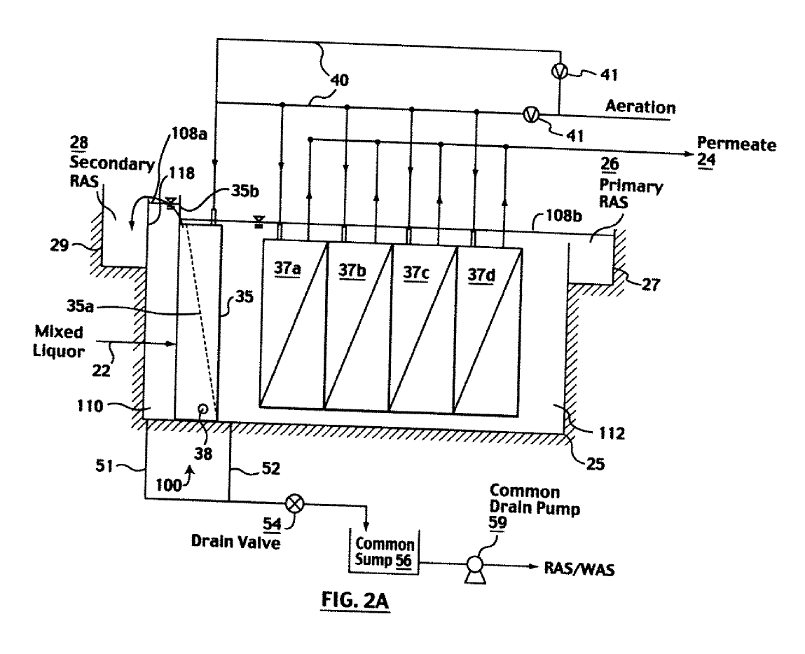

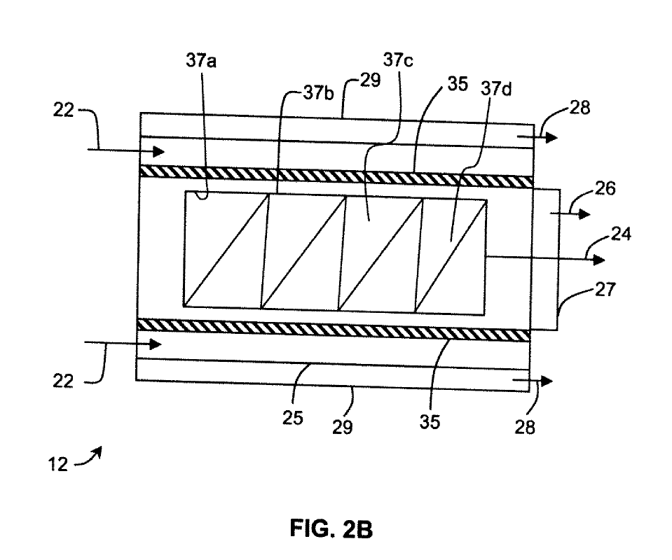

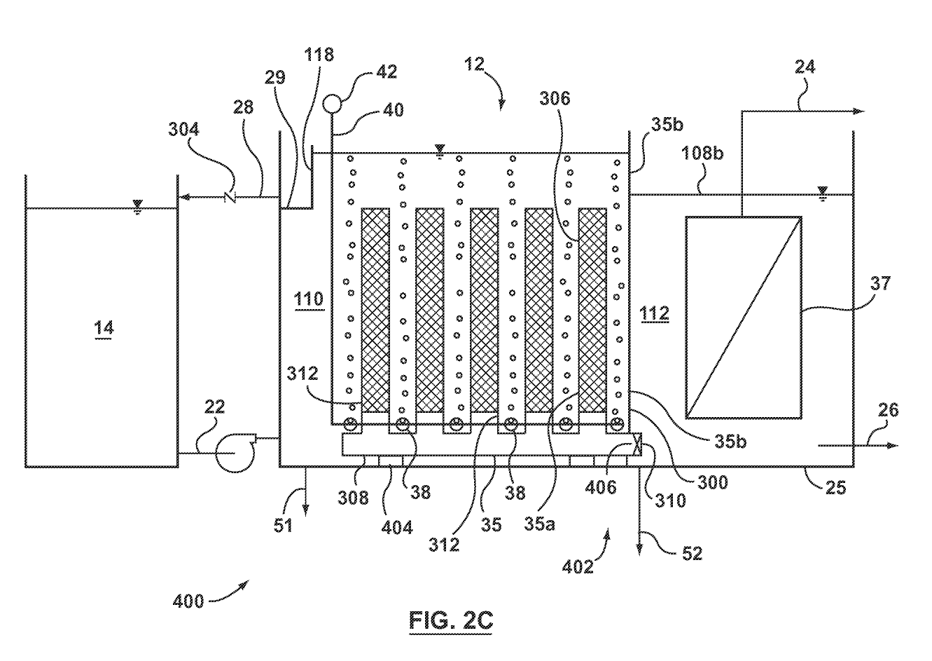

Similarly, designs according to options (c) or (d) of FIG. 10 also allow increased flow. For example, 16 cylindrical screens of 9′ height and 12″ diameter spaced at 14.5 inches centre to centre provide a screening surface area of 465 square feet. This should be sufficient to allow flows of 3-6 Q to 64 to 224 ZeeWeed™ 500 elements or 1 to 4 cassettes. In all of the cases discussed above, the number of membrane elements or flow, as a multiple of Q, can be increased by altering the plan view shape of a membrane tank. For example, if the membranes and tank walls are rearranged to make the tank larger in one dimension, the static screens 35 can be placed across the larger dimension with the inlet 116 to the tank moved to feed into the upstream area 110. For example, a static screen 35 may run down one or both edges of a long tank rather than across the front of such a tank, for example as shown in FIG. 2B. The use of one or more static screens 35 with large SSAᵣₐₜᵢₒ, locating the static screen 35 across the length of a tank, or having a cross or recirculating flow across the face of the static screen 35 may be appropriate for using the screening assembly 100 in large municipal wastewater treatment plants or other intense applications.

In operation, a repeated cycle of forward filtration and backwashing is the ordinary operation mode. During this mode of operation in a bioreactor, trash or undesirable solids of a size caught by the screening apparatus 100 build up in the biomass to a concentration generally equal to the ratio of SRT to HRT multiplied by the concentration of such solids in the feed. During an optional mode of operation, used for example at night or other periods when the flow rate is reduced, the screening apparatus 100 is run for an extended period of time, for example 1 hour or more, without backwashing. This causes the trash or undesirable solids concentration to increase in the upstream section 110. At the end of this period, the trash or undesirable solids are wasted by overflow or drain, for example to a waste activated sludge holding tank. This removes large amounts of trash or undesirable solids from the system in excess of that ordinarily removed with wasted sludge. The process may be repeated, if desired, to remove more trash. The average concentration of solids retained by the screening apparatus 100 may thus be less than the concentration described above under ordinary operation. Using this additional concentration and wasting procedure may reduce or eliminate the need for head works or side stream screening.

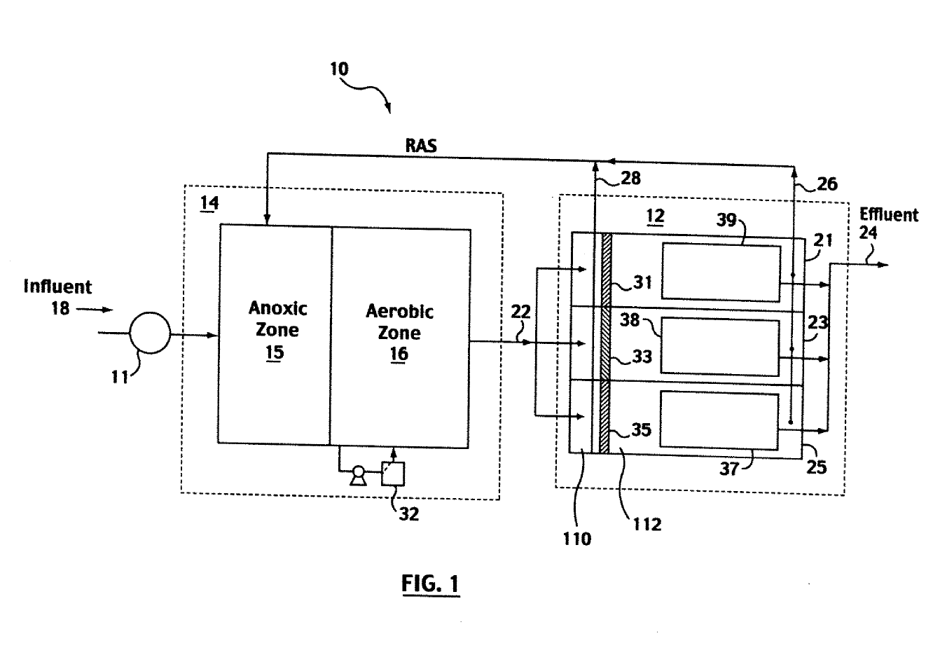

FIG. 1 is a schematic diagram illustrating an example of a waste water treatment system 10. The waste water treatment system 10 includes an optional pre-screen filter 11, a bioreactor 14 and a membrane zone 12 respectfully arranged in series but with some recycle. Briefly, raw sewage 18, alternately called influent or feed, flows into the waste water treatment system 10, optionally through the pre-screen filter 11 and treated water 24, alternately called permeate or effluent, flows out of the waste water treatment system 10 through the membrane zone 12.

In some embodiments the pre-screen filter 11 is designed to screen raw waste water 18 (i.e. raw sewage) to an input level acceptable in a conventional activated sludge plant, which typically means that debris (e.g. wood, fish, trash, hair and fiber bundles, etc.) larger than 3 mm to 6 mm in cross-section are stopped by the pre-screen filter 11, whereas smaller pieces of debris (including hair and the like) are permitted to pass through into the waste water treatment system 10. In alternative embodiments, a pre-screen filter 11 is adapted to meet the requirements for a particular facility that it is employed in. Consequently, debris smaller or larger than described above may be permitted to pass through a particular pre-screen filter 11.

Generally, the bioreactor 14 is made up of, without limitation, alone or in various combinations, one or more anaerobic zones, one or more anoxic zones, or one or more aerobic zones. According to the specific example illustrated in FIG. 1, the bioreactor 14 is made up of an upstream anoxic zone 15 that flows into a downstream aerobic zone 16. In some embodiments the sewage in one or both zones 15 and 16 is continuously stirred. The bioreactor 14 also includes an optional side-screen filtering system 32 that is provided to further reduce the concentration of hair, trash and other fibrous materials in the bioreactor 14. Details relating to a side-screen filtering system 32 are provided within the applicant's U.S. Pat. No. 6,814,868 issued on Nov. 9, 2004, which is hereby incorporated in its entirety by this reference to it.

Additionally, according to the specific example illustrated in FIG. 1A, the membrane zone 12 is fluidly connected downstream of the bioreactor 14 through exit stream 22. Flow through the exit stream 22 may be by gravity flow or pumped. The membrane zone 12 may be made up of one or more membrane tanks 21, 23 and 25 which may be separate tanks or partitioned areas of a larger tank. Membrane tanks 21, 23, 25 each have a respective static screen 31, 33 and 35. Each static screen 31, 33 and 35 sealingly covers and intercepts a respective inlet flow path for the corresponding membrane tank 21, 23 and 25 so that the amount of fibers and trash that pass into the membrane tanks 21, 23 and 25 is substantially reduced during operation. Moreover, as will be described in detail further below with reference to FIG. 2A, each membrane tank 21, 23 and 25 contains one or more respective membrane assemblies 37, 38 and 39. Each membrane tank 21, 23 and 25 is preferably designed to closely confine the respective membrane assemblies 37, 38 and 39 to reduce the required area of the membrane tanks 21, 23 and 25. For example, the membrane tanks 21, 23, 25 may have a width from 0 to 60% wider than the width of the respective membrane assemblies 37, 38 and 39.

A first number of respective outlets of the membrane assemblies 37, 38 and 39 are fluidly connected to the effluent stream 24, which is the treated water or permeate stream. A second number of respective outlets of the membrane tanks 21, 23 and 25 are fluidly connected to a common primary Return Activated Sludge (RAS) stream 26; and, similarly, a third number of respective outlets of the membrane tanks 21, 23 and 25 are fluidly connected to a common secondary RAS stream 28 or RAS by-pass. The RAS stream 26 may carry a flow of 3-5 Q. The secondary RAS stream 28 may carry flow only from backwashing the static screens 31, 33, 35, or may also carry a continuous recirculating flow of, for example, 0.5-2 Q. The primary and secondary RAS streams 26 and 28 are combined and flow back into the bioreactor 14. Specifically, in the example of FIG. 1A, the combined primary and secondary RAS streams 26 and 28 are fed back into the anoxic zone 15. In other embodiments, the feed back of RAS from any number membrane tanks may flow, without limitation, to a suitable combination of one or more anoxic zones, one or more anaerobic zones, and one or more aerobic zones or to a point upstream of the bioreactor 14.

In operation the influent stream 18 enters the waste water treatment system 10 through pre-screen filter 11 which screens the influent stream 18 so that larger pieces and bundles of debris are kept out of the waste water treatment system 10.

The screened influent stream 18 then enters the anoxic zone 15 of the bioreactor 14 where it is processed accordingly and becomes and merges with mixed liquor. Mixed liquor from the anoxic zone 15 flows to the aerobic zone 16, where it is again processed accordingly into, merges into and becomes an aerated mixed liquor.

The aerated mixed liquor exits the bioreactor 14 through exit stream 22, which is, in turn, fed into the membrane zone 12. Within the membrane zone 12 the mixed liquor is delivered into the membrane tanks 21, 23 and 25 by first passing through the corresponding static screens 31, 33 and 35, respectively. The static screens 31, 33 and 35 serve to protect the membrane assemblies 37, 38 and 39 within the respective membrane tanks 21, 23 and 25 from, for example, trash such as roped and balled bundles of hair that have formed together within the bioreactor 14 from smaller strands, smaller particles that passed through the pre-screen filter 11, or trash that has re-contaminated the bioreactor 14. As will be described in detail below with further reference to FIG. 2A, one way of dealing with the screenings that cannot pass through the static screens 31, 33 and 35 is to flush them back into the bioreactor 14 via the secondary RAS stream 28. In some embodiments, the flow rate through the secondary RAS stream 28 is about the same as the average flow rate Q, for example between 0.5 and 1.5 Q, of the waste water treatment system. However, flow in the secondary RAS stream 28 may not be at a constant rate and the flow rates in the sentence above may be averages over periods of time. For example, where the screen 25 is backwashed in a way that causes backwashed liquid or solids to flow into secondary overflow weir 29 to join the secondary RAS stream 28, as will be described further below, the flow rate in the secondary RAS stream 28 may be minimal or zero while liquid flows in a forward direction through the screen and 4-6 Q during a backwash of the screen 35. As mentioned above, a constant flow, for example of 0.5-2 Q, through the secondary RAS stream 28 may also be superimposed onto these flows. Flow in the secondary RAS stream 28 may be by gravity, for example when the membrane zone 12 is at a higher elevation than the bioreactor 14, or by pump, optionally after flowing by gravity into a well, sump or channel, for example if the bioreactor 14 is at a higher elevation than the membrane zone 12. Alternatively or additionally, screenings may be removed from the waste water treatment system 10 and disposed of as Waste Activated Sludge (WAS).

A treated effluent stream 24 exits from the permeate side of the membrane assemblies 37, 38 and 39. RAS, including material rejected by the membrane assemblies in the membrane zone 12, is fed back to the bioreactor 14 via the primary RAS stream 26. In some embodiments, the flow rate through the primary RAS stream 26 is about three or four times the average flow rate Q, for example between 2.5 Q and 4.5 Q, of the waste water treatment system. Required flow through the static screens 31, 33, 35 may be 3.5-5.5 Q. Alternatively or additionally, waste sludge may be removed from the waste water treatment system 10, for example as described further below, and disposed of accordingly.

Independently, an optional side-screen filtering system 32 may remove a portion of the mixed liquor from the bioreactor 14 in order to remove trash, hair and other fibrous materials from the mixed liquor before re-introducing the screened mixed liquor into the bioreactor 15. Specifically, as shown in FIG. 1, the optional side-screen filtering system 32 is coupled to remove a portion of the mixed liquor from the aerobic zone 16 of the bioreactor 14 and re-introduce the screened mixed liquor into the aerobic zone 16.

In some embodiments, a side-screen filtering system operates at a constant flow rate that may be 25% to 75% of the average flow rate Q through a waste water treatment system. In some related embodiments one or more side-screen filtering systems can be placed at various other locations within a waste water treatment system for screening the mixed liquor and subsequently re-introducing it to the same location or another location within the waste water treatment system. Again, details relating to side-screen filtering are provided within the applicant's U.S. Pat. No. 6,814,868. The side screen filtering system reduces the concentration of roped or balled hair or similar materials and other trash in the bioreactor 14, but does not eliminate them.

The flow of mixed liquor through waste water treatment system 10 can be facilitated in a number of ways. According to a first option mixed liquor is pumped from the bioreactor 14 to the membrane zone 12; and, gravity is employed to circulate the combined RAS stream back to the bioreactor 14. The level of the mixed liquor in one or more of the membrane tanks 21, 23 and 25 is controlled by the height of overflow weir 27 to the primary RAS stream 26. Advantageously, floating foam and/or scum is passively delivered back to the bioreactor 14 from the membrane zone 12 over the overflow weir 27, although other means for RAS recirculation and foam or scum control can be used. Alternatively, according to a second option, mixed liquor passively flows (e.g. assisted by gravity) from the bioreactor 14 to a membrane zone 12; and, the combined RAS stream is circulated to the bioreactor 14 using a pumping mechanism. Advantageously, in accordance with the second option, the RAS pump does not have to process the permeate flow, reducing the peak pumping requirements of the system.

Referring now to FIG. 2A, illustrated is a schematic diagram of a side view of the membrane tank 25 of FIG. 1 that is arranged with the corresponding static screen 35 to provide an integrated screening apparatus 100. The static screen 35 is positioned close to the inlet side of the membrane tank 25 to provide an upstream section 110. Specifically, the static screen 35 extends across the width of the membrane tank 25, extending from the bottom of the membrane tank 25 to at least the design maximum mixed liquor level, and generally sealingly cooperates with the bottom and sides of the membrane tank 25. A non-porous surface 35b may extend from the top of a frame around the screen surface 35a below the downstream water level 108a to above the upstream water level 108a. In such an arrangement, the static screen 35 divides the membrane tank 25 into two portions, the upstream section 110 and downstream section 112. The upstream section 110 is fluidly connected to the exit stream 22 which is an inlet to the upstream section 110 bringing in mixed liquor, either by pumped or gravity flow. The downstream section 112 contains the membrane assemblies 37, 38 and 39 (described below). Membrane tanks 21 and 23 are substantially identical to membrane tank 25. The static screen 35 includes a coarse bubble aerator 38 for gas scouring and gas flow induced backwashing. Aerator 38 is coupled to receive pressurized gas (typically through an air blower, through aeration screen 40.

The membrane tank 25 houses a number of membrane assemblies 37a, 37b, 37c and 37d that are placed downstream of the static screen 35 (i.e. in the second portion of the membrane tank 25). In some embodiments the membrane assemblies are in a cassette form, such as, for example, a ZW-500d cassette available from Zenon Environmental Inc. now GE Water & Process Technologies. As shown in FIG. 2B, the membrane tank 25 may also be re-arranged, for example by providing a static screen 35 along one or both lengths of the membrane tank 25 to provide larger static screens 35 for membrane assemblies 37 of the same membrane surface area. Optionally, the static screens 35 may surround the membrane assembly 37 on all four sides in plan view with primary RAS 26 withdrawn through the floor of the membrane tank 25 below the membrane assemblies 37. Further optionally, the static screens 35 may encapsulate the membrane assemblies 37, for example by providing screening surfaces 35 or non-porous surfaces 35b on all 6 sides of a rectangular cassette of membrane assemblies 37, preferably with primary RAS 26 withdrawn by pipe passing through a static screen 35 and with screen backwashing by backwashing the membrane assembly 37.

The membrane tank 25 also includes two drains 51, 52. A larger primary drain 51 is located upstream of the static screen 35 and a smaller secondary drain 52 is located downstream of the static screen 35. The primary and secondary drains 51, 52 share a fluid connection to a drain valve 54, which is in fluid communication with a common sump 56. With further reference to FIGS. 1A, 1B, 1C and 1D, the common sump 56 (not shown in these Figures) may receive drainage from all or a plurality of the membrane tanks 21, 23 and 25. The common sump 56 is in fluid communication with a common drain pump 59. The common drain pump 59 is arranged to output a RAS/WAS (Waste Activated Sludge) stream from the collection of membrane tanks 21, 23 and 25 via the common sump 56.

In operation, mixed liquor enters the membrane tank 25 on the inlet side of the membrane tank 25 upstream of the static screen 35 (i.e. in the upstream section 110 of the membrane tank 25). The static screen 35 serves to filter out a substantial portion of roped and balled bundles of hair and the like from the mixed liquor entering the membrane tank 25 before the mixed liquor is permitted to flow to the membrane assemblies 37a, 37b, 37c and 37d. The roped and balled bundles of hair and the like that are caught by the static screen 35 and are flushed eventually through the fluid connection to the common secondary RAS stream 28, which may be designed, for example, to support a flow generally equal to average inlet flow rate Q of the waste water treatment system 10, for example between 0.5 and 1.5 Q. Moreover, periodic reverse flows to clean the static screen 35 may also take place employing the fluid connection to the secondary RAS stream 28 to return sludge flowing in a reverse direction through the screen to the bioreactor 14.

The mixed liquor that flows through the static screen 35 or large screen 93 flows through the membrane assemblies 37a, 37b, 37c and 37d that are each made up of a number of membrane fibers. Consequently, the static screen 35 or large screen 93 protects the membrane assemblies 37a, 37b, 37c and 37d by continuously screening the mixed liquor directly before the mixed liquor is introduced to the membrane assemblies 37a, 37b, 37c and 37d. The membrane fibers are hollow and porous, which allows clarified water, known as permeate, from the mixed liquor to flow into the hollow interiors of the membrane fibers. The filtered permeate water is then drawn from the membrane tank 25 via a permeate stream into the effluent stream 24.

The aeration stream 40 is delivered to each of the membrane assemblies 37a, 37b, 37c and 37d. The aeration stream 40 is coupled to the bottom of each of the membrane assemblies 37a, 37b, 37c and 37d and releases bubbles to provide air scouring for the respective membrane fibers (not shown). The aeration stream 40 is also connected to coarse bubble aerators 38 below the static screens 35 to provide bubbles which contact and rise past the static screens 35. This helps reduce and delay fouling of the static screens 35 and to float retained solids to the secondary RAS stream 28. Alternately, separate aeration streams 40 may be provided to the membrane assemblies 37a, 37b, 37c, 37d and the static screen 35. Air, or other gases, in the one or more aeration streams 40 may be provided continuously, intermittently or cyclically. Air valves 41 may be operated to allow air, or other gases, to be provided to the screen 35 or membrane assemblies 37, or both, at any given time. For example, the supply of gases may be provided to the membrane assemblies 37 for most, for example between 50% and 95%, of operation time, and intermittently diverted to the screen 35. Alternately, gases may be supplied to the membrane assemblies 37 without regard to the needs of the screen 35, which is aerated when desired without regard to the needs of the membrane assemblies 37. However, since aerating the screen 35 reduces the density of water upstream of the screen 35, which interferes with flow of liquids to the membrane assemblies 37, the screen 35 may be aerated only periodically, for example directly before and/or during a screen 35 backwash as described below. Alternately, or additionally, the screen 35 may be aerated periodically with sufficient intensity to cause a backwash of the screen 35 by reducing the density of water upstream of the screen 35. Liquids backwashed through the screen 35 during intense aeration may flow to the secondary RAS channel 28 or mix with an upstream zone or other part of the total system. These comments, and others referring to one screen 35, apply to the other screens 31, 33, 93.

For example, a screen 35 in an embodiment as shown in FIG. 2A may be operated with a maximum head loss to flow through the screen of 15 to 30 cm. During normal operation of the screen 35, liquid flows through the screen 35. While liquid flows through the screen, air is provided to the aerator 38 of the screen 35 at a rate between about 0.5 and 2.0 scfm per horizontal linear foot of screen 35. This provides some cleaning of the screen 35 without causing an unacceptable head reduction for flow though the screen 35. During this time, very little, if any, liquid or solids overflows into the secondary RAS stream 28. Air may also be provided to the membrane assemblies 37 during this time as desired. Periodically, for example between about once a minute and once an hour, the screen 35 may be backwashed by providing a higher rate of aeration. For example, air may be provided to the aerator 38 of the screen 35 at a rate between about 8 and 12 scfm per horizontal linear foot of screen 35, for a backwash period of between about 5 to 20 seconds. If necessary, the air valves 41 may be operated to divert air from the membrane assemblies 37 to provide the increased airflow to the screen 35. This higher rate of aeration causes a decrease in the density of the liquid upstream of the screen 35, or otherwise causes liquid to flow backwards through the screen 35. Simultaneously, solids and liquid are floated or flow upwards upstream of the screen 35 and overflow into the secondary RAS stream 28. After the backwash period, the rate of aeration returns to the lower level to resume normal forward flow of liquid through the screen 35. The membrane assemblies 37 may be backwashed just before or while the increased airflow is provided to assist in backwashing the screen 35. In water filtration systems which typically have larger membrane surface areas in relation to the influent flow Q, of flow into screening apparatus 100, than wastewater plants, the volume of water added to the downstream section 112 during a membrane backwash may be significant and may even be sufficient to backwash the screen 35 alone.

Sludge that is not extracted through the membrane fibers from the membrane tank 25 generally flows through the fluid connection to the common primary RAS stream 26, although some is wasted through the drains 51, 52.

In an additional, optional, cleansing process, the static screen 35 (as well as static screens 31 and 33) can be purged by backwashing and draining solids from upstream of the static screens 31, 33, 35. In order to do this the drain valve 54 is opened and the mixed liquor flows out through the primary and secondary drains 51 and 52, respectively. Since the primary drain 51 is larger than the secondary drain 52 a larger amount of the mixed liquor flows through the primary drain 51 causing the mixed liquor in the membrane tank 25 to flow in the opposite direction through the static screen 35 than it normally flows when the drain valve 56 is closed. At this time flow of mixed liquor through exit line 22 may be slowed or stopped or the drain flow rates may be made to exceed the mixed liquor flow rate through exit line 22. Reversing the flow of the mixed liquor through the static screen 35 removes at least some of the trash, debris, grime, fibers, etc. that have collected on the upstream side of static screen 35. At least some of this released material, as well as solids too dense to be floated to secondary RAS stream 28, are drained out of the area upstream of the static screen 35. Alternatively, this operation can be facilitated by pumps that can be controlled to cause a reversal in the normal direction of a mixed liquor flow through one or more of the membrane tanks 25. The membrane assemblies may be backwashed directly before or during the draining to assist in backwashing the screen 35.

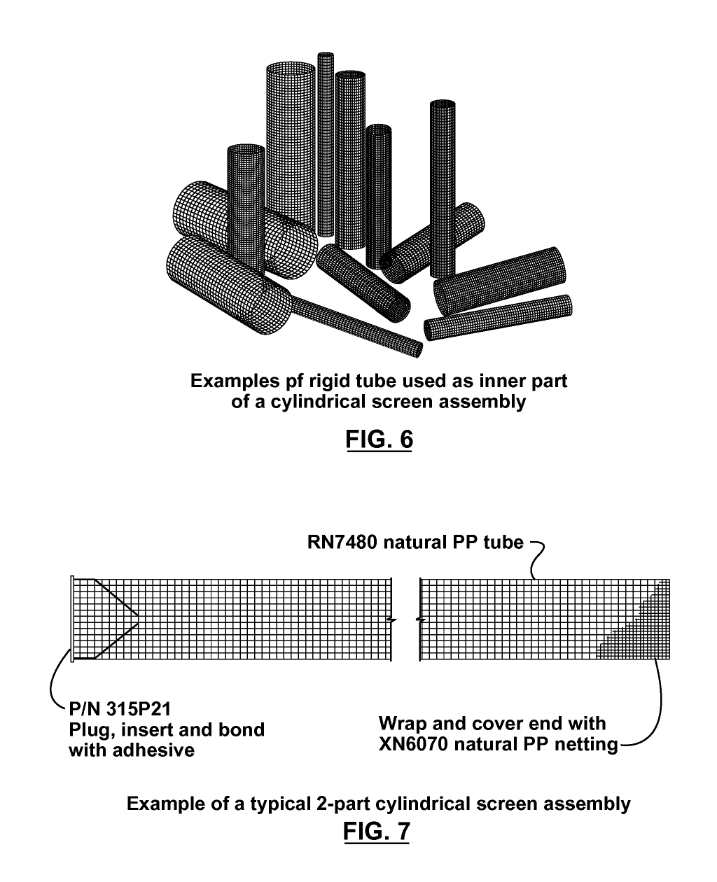

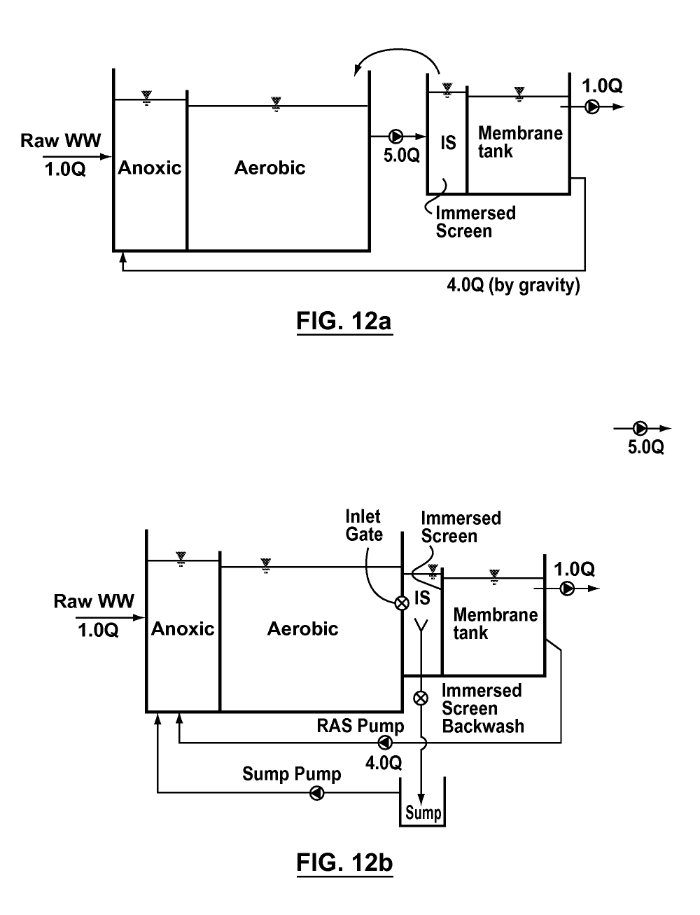

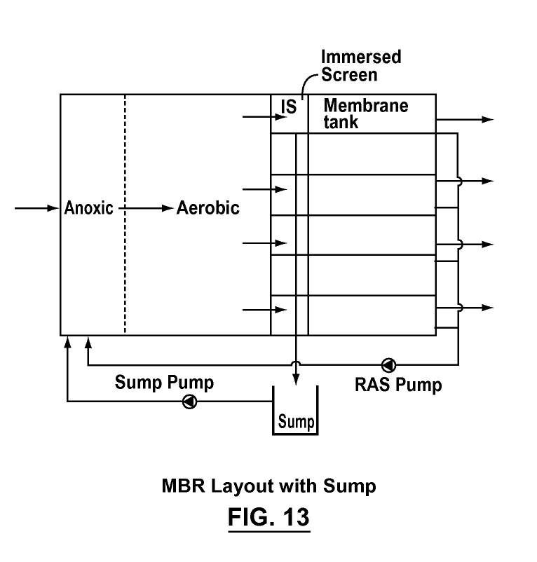

FIG. 2C shows another treatment system 400 having a bioreactor 14 and a membrane zone 12 and a screening apparatus 402 integrated into a membrane tank 25. The screening apparatus 402 may alternately be in a separate tank upstream of the membrane tank 25. The size of the downstream section 112 of the membrane tank 25 containing the membrane assemblies 37 and the bioreactor 14 have been reduced in the figure to allow an upstream section 110 of the membrane tank 25 to be drawn larger. Flow from the bioreactor 14 to the membrane zone 12 is by pump 302 in the exit line 22. RAS 26, 28 flows by gravity back to the bioreactor 14 through pipes (pipe from RAS 26 not shown) with check valve 304. Alternately, a “pump from” arrangement may be used as described in U.S. Patent Application No. 60/798,294 filed May 8, 2006 to Theodoulou et al. or as descried in relation to FIG. 12, part b. and FIG. 13 herein. The upstream and downstream sections 110, 112 of the combined membrane tank 25 and screening apparatus 100 are separated by a partition 300 that also acts as a non-porous surface 35b of a static screen 35. Static screen 35 rests on legs 404 on the floor of membrane tank 25. Optionally, static screen 35 may rest directly on the floor of membrane tank 25 or be held in a frame suspended for the top of membrane tank 25. The static screen 35 has a set of open bottomed and closed or screened capped cylinders 306, having 0.75 mm openings, which function as screening surfaces 35a. Optionally, screening surfaces of other shapes, materials or opening sizes may be used. The cylinders 306 may be made in two parts as described in U.S. Patent Application No. 60/797,773 filed on May 5, 2006 by Cote et al. or as described herein with reference to FIGS. 6 to 11. The cylinders 306 are connected to a header 308 having an outlet 310 passing through the partition 300 to the downstream section 112. The bottom 10-20 cm of the cylinders 306 may, optionally, have non-porous sections 312. These non-porous sections 312 may be a product of the construction of the header 308 or may be provided to enhance a horizontal flow of water to aerators 38. A valve 406 may be provided in outlet 310 and can be closed when desired to allow for draining the upstream area 110 without draining the downstream area 112 or vice versa. The upstream section 110 may be aerated to scour or shake material from the static screen 35 before draining. Such a process may be useful, for example as an alternate regular cleaning method, as a method used from time to time to remove solids from the upstream section 110 that cannot be floated over the overflow 118 or at the end of a night or low flow operation mode described earlier in which solids have been allowed to accumulate in the upstream section 110. Drained material may be, for example, further processed, wasted or recycled.

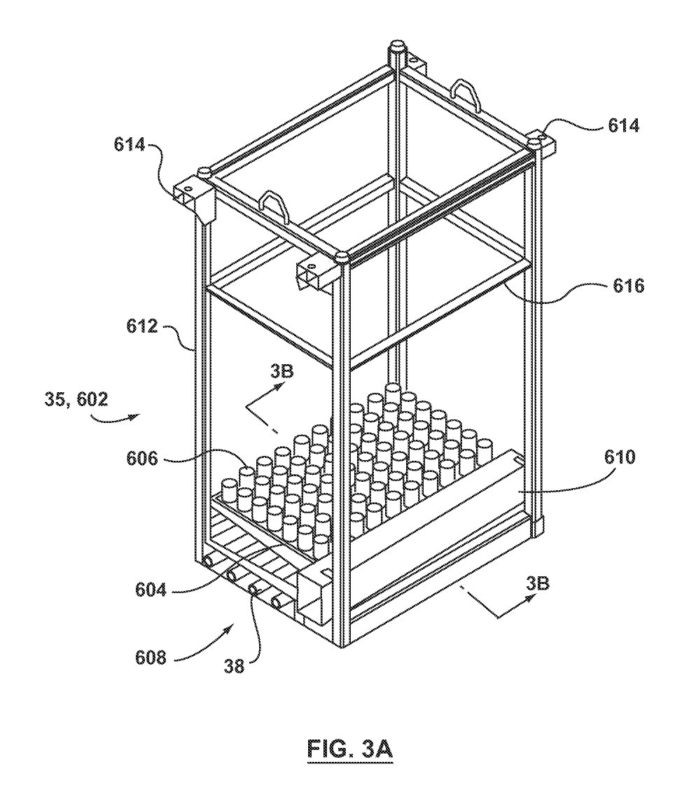

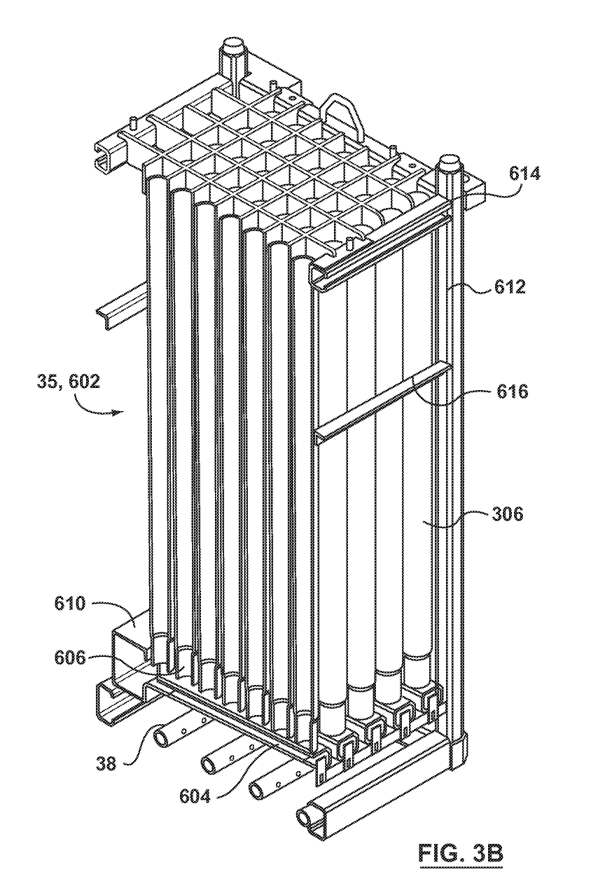

FIGS. 3A and 3B show an alternate screening apparatus 602 for use in treatment system 400 of FIG. 2C. In screening apparatus 602, bottom collection pipes 604 have inlets 606 for receiving the bottoms of screen cylinders 306, not shown, oriented vertically. The open bottoms of the cylinders 306 are placed over and attached to inlets 606, for example by being clamped over the inlets 606, to connect cylinders 306 to a collection system 608 comprising the tubes 604 and, optionally, a header 610. The collection system 608 directs the screened water into the membrane portion for the tank via header 610 which may pass through a hole in tube wall 300 of FIG. 2C into downstream section 112. This design utilizes continuous downward water velocity in the cylinders 306 to minimize the ability for solids to settle or otherwise collect within the cylinders 306.

An enclosure frame 612 captures the screen cylinders 306 as well as houses the collection system 608. In addition the screen aerators 38 are incorporated into the frame 612. Spaces between collection pipes 604 allow bubbles to rise from aerators 38 to the screen cylinders 306. The frame 612 may be bolted to the top or walls of a tank 25 through the attachment fittings 614 at the top of the frame 612. One or more of a guardrail 616, a divider 618 or other support structures may be used to keep the cylinders 306 oriented vertically.

Referring to FIGS. 6 to 11, a screen assembly can be built from an elongated screen. The elongated screen may have a round section but other shapes are also possible, including square and star-shaped. The cross-section may or may not vary along the length, for example a cylinder or rectangular paralleliped may be used but a conical or pyramid shape is also possible.

A screen assembly (SA) may be made as a 1, 2 or 3 or more part assembly to be self-supporting and provide the required mesh opening, for example on the outside. A two-part SA may be built as follows:

The inner part may be a rigid tube built from coarse netting material which provides mechanical support for the outer part while minimizing resistance to flow. Rigid tubes are available from several suppliers including InterNet (http://internetplastic.com/filtration.htm), in a variety of dimensions, for example as shown in FIG. 6 or in even longer tubes. A suitable tube available from InterNet is part RN7480 with the following specifications:

| | |
|---|---|
| Inside diameter (inches) | 2.865 |
| Outside diameter (inches) | 3.045 |
| Wall thickness (inches) | 0.090 |
| MD strands | 35 |
| Cross stands (# per inch) | 3.75 |
| Hole size (inches) | 0.2 × 0.2 |
| Opening (%) | 50 |

The outer part may be a plastic netting that surrounds the rigid tube. The outer part may be, for example welded, glued, stitched or clamped to the inner part, for example at one or both of it ends or in a line along the length of the SA. Plastic netting are available in diamond, rectangular and square opening shapes in a variety of dimensions from several suppliers. A suitable tube available from InterNet is part XN6070 with the following specifications:

| | |
|---|---|
| Nominal hole size (inches) | 0.021 × 0.027 |
| Thickness (inches) | 0.014 |
| Roll width (inches) | 43.5 |
| Strands per inch (MD × CD) | 27.6 × 25.0 |
| Opening (%) | 35 |

The SA can be made from any plastic. For example, polyolefins (PP or PE) may be used and are low cost and can be welded.

The diameter, or the diameter of a circle of equivalent average cross-sectional area, of a SA can vary, for example from 5 cm to 15 cm, or from 7 cm to 12 cm. A CA built from parts RN7480 and XN6070 is shown in FIG. 7.

A SA could also be build from a single rigid tube which has to be selected to provide the required hole size for the target application. Other materials, such as metals, can also be used.

A SA could also be built from 3 parts, where each part can play the following roles:

Part 1: inner coarse tube to provide mechanical support

Part 2: middle layer to provide required hole size

Part 3 outer coarse layer to support middle layer during backwash, to protect a fragile middle layer, and/or to promote the formation of a cake layer on the outer surface of the middle layer

One end of a SA may be capped or covered with netting, for example by sewing an end covering piece of netting to the outer part of the netting at one end of the SA, while the other end is in fluid communication with the downstream section of the immersed screen through a collector as described below.

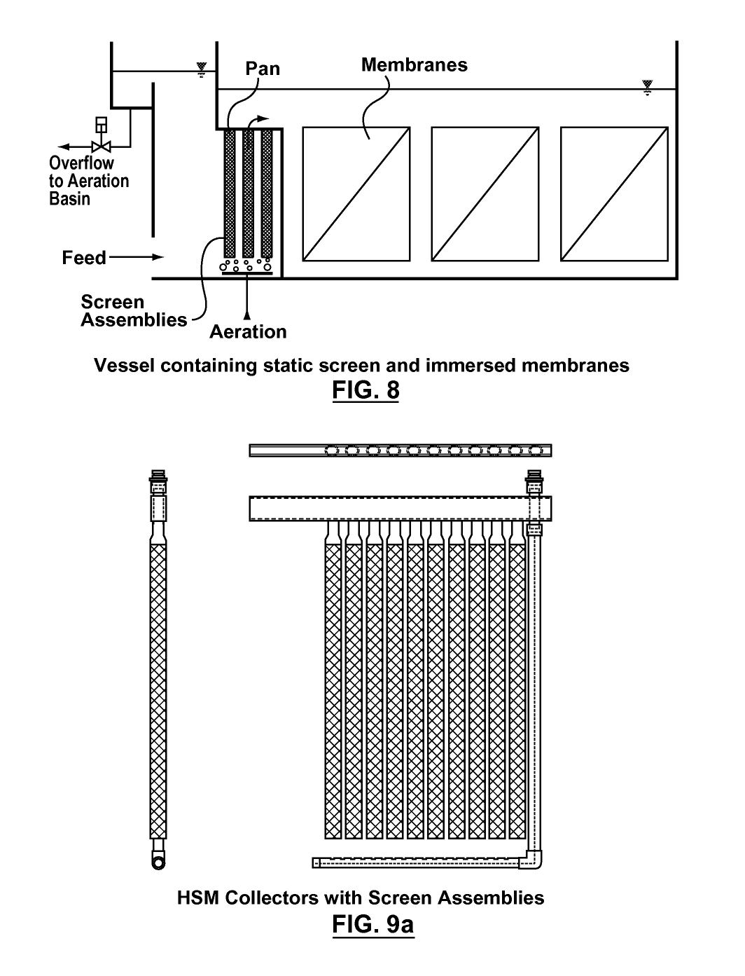

The purpose of the collector is to hold one or more SAs into place and transfer the screened liquid to the downstream section of the immersed or static screen. The screened liquid may then travel to another downstream vessel or area, for example a membrane tank or zone. The collector may be used to install the SAs into a section of a tank separated by a vertical dividing wall from a section containing an immersed membranes (FIG. 8).

The collector can be, for example, a HSM conduit or a pan as illustrated in FIG. 8.

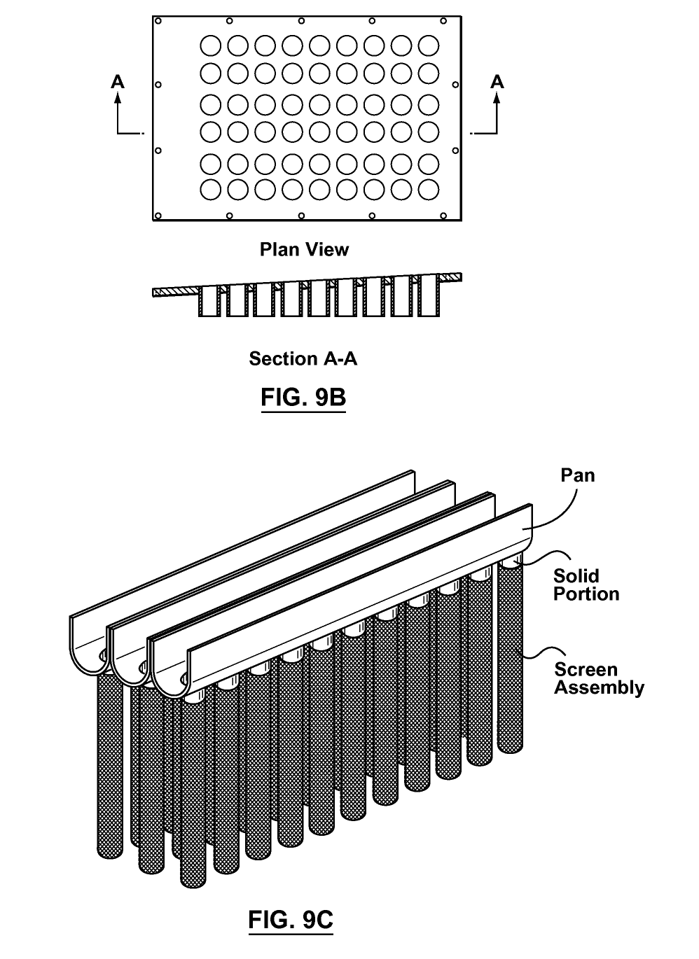

A hollow structural member (HSM) is a conduit, for example with a round, square or rectangular cross-section, to which SAs are attached (FIG. 9a). HSMs may be laid out horizontally across the screen section of a tank with the SAs facing down, up or horizontally or laid out vertically with the SA's horizontal. The HSM conduits go through the vertical dividing wall and put the downstream side of the immersed screen in fluid communication with the immersed membrane section. Multiple HSM conduits may be laid out side-by-side with a gap to allow trash, air and water to rise and overflow during a backwash. Example dimensions are as follows:

Width of the HSM: 5-25% larger than the OD of the SA

Height of the HSM is determined by length and cross-section required for flow (typically 2-3 times width)

From 5 to 50 SAs per HMS, spaced by a distance “x”

Gap between HSMs: “y”

Distances “x” and “y” may be 4 to 10 times larger than the largest piece of trash to be removed by the immersed screen. For example, if the largest piece of trash is 6 mm (i.e., the opening of a head-works coarse screen in a MBR), “x” and “y” may be between 24 to 60 mm.

An immersed screen installation based on HSM conduits is shown in FIG. 10; the liquid above the HSM is un-screened. The feed is introduced to the bottom portion of the screen section. During backwash, the trash, air and water first flow vertically up above the HSM conduits and then flow horizontally to an overflow trough.

A pan collector is a horizontal structure that holds the SAs and screened fluid directly above it. The pan can be built as a flat plate with SA distributed in one or both directions across the plate or as a series of elongated U-shaped pans (FIG. 9c) that can be assembled side-by-side. Gaps between SAs are based on the criteria given above.

An immersed screen installation based on a pan collector is shown is in FIG. 11; the liquid above the pan is screened. The feed is introduced in the bottom portion of the screen section. During backwash, the trash, air and water remain below the pan and flow horizontally to an overflow trough.

In both collector concepts, a section of SA close to the collector may be solid (without screening surface or other openings) to inhibit air from escaping to the downstream side. This section can also be of a smaller diameter than the screen section to increase the cross-sectional area for horizontal flow under the pan during backwash. The length of the collector may be as long as required to support enough SAs across the width of a tank, or provide the required SSAᵣₐₜᵢₒ to meet the required flow through the static screen.

SA can be attached and sealed to the collector by a number of means: O-ring, gasket, glue, welding, etc. They can be removable or permanently fixed. For example, pieces of solid (without openings) tubes may be threaded, welded etc. to a pan or HSM. These tubes may have a rubber ring slipped over their outside surfaces near their ends. The rubber ring may have an inside diameter like the outside diameter of the solid tube and an outer diameter like the inside diameter of a SA. A SA may then be slipped over the rubber tube and clamped, for example with a band pipe clamp, in place.

Referring to FIGS. 12 and 13, membrane bioreactors can be designed hydraulically as “pump-to” or “pump-from” configurations, referring to the method used to circulate mixed liquor through the membrane tank (FIG. 12). While a MBR treats a flow rate of 1.0×Q, a much higher flow rate needs to be recirculated through the membrane tank for the following reasons:
1. To prevent excessive build-up of MLSS in the membrane tank upon withdrawal of permeate
2. To recycle the mixed liquor (ML) to the to head of the plant for biological nutrient removal (as illustrated in FIG. 12)

The ML flow rate to the membrane tank may range between 3 and 10×Q, for example 5Q as shown in FIG. 12.

The pump-from configuration is sometimes used because the flow rate of ML pumped is lower by 1 Q (4 Q versus 5 Q in FIG. 12), translating in lower energy consumption.

A significant difference between the 2 configurations is how the levels in the MBR tanks vary as in reaction to the changes in wastewater flow rate to the plant. In a typical MBR, the flow rate extracted by the permeate pumps is varied to maintain a target constant level in the biological or membrane tanks. However, to a certain extent, the biological or membrane tanks are used for equalization and their level can vary by up to 50 to 100 cm.

Backwashing an immersed screen by exposing the upstream side of the screen to a large flow rate of air to induce reverse flow through the screens and airlift the backwash ML containing the trash into the biological tanks (directly or through a channel) is limited by the maximum lift, for example about 20-40 cm, that can be generated by aeration.

The air-induced backwash method can easily be used in a pump-to configuration (FIG. 12a) because the system can be designed so that the minimum level in the immersed screen upstream compartment is always above the maximum level in the biological tanks.

However, the air-induced backwash method may be difficult to use in a pump-from configuration (FIG. 12b) if the level variation in the tanks (50-100 cm) is much larger than the maximum lift of the air-induced backwash (20-40 cm). In other words, the weir for the air-induced backwash has to be located at a pre-selected elevation; given the level variation in the tanks, a chosen elevation may not ensure backwash in all situations.

In another overflow method and apparatus, a submerged overflow weir is provided in the upstream section of the immersed screen at an elevation that will ensure backwash of the screen (FIG. 12b). This elevation is selected to be slightly, for example a few cm, below the minimum operating water level of the membrane tank. The discharge line from this overflow is equipped with a valve which is normally closed. When the immersed screen needs to be backwashed, this valve is opened and the level in the upstream section of the immersed screen is suddenly lowered to the weir level, inducing backwash of the screen. This backwash operation will last 20-60 s and can be scheduled to take place at the same time as the backwash or relaxation of the membranes. In this method, the airflow rate to the screens does not need to be increased during backwash but optionally can be allowing the weir to be higher, possibly above the minimum operating water level of the membrane tank but still at a level that causes water to backwash through the screening surface when the area upstream of the screening surface is aerated.

The immersed screen backwash ML may be discharged into a sump. A pump (which can be designed to run continuously) transfers this ML back to the biological tanks. For example, there may be 5-10 backwashes per hour; each backwash may last 20-40 seconds. To provide efficient backwash, the instantaneous backwash flow rate may be 5-10% larger than the flow from the biological tanks to the immersed screen. Based on these conditions, it can be calculated (example below) that the required volume for the sump is less than 1% of the volume of the biological tanks or less than 10% of the volume of the membrane tanks. The sump pump (if run continuously) may be designed for a flow rate of 0.25-0.75×Q.

As an option, the inlet gate to the membrane tank, including the upstream section of the screen, can be partially or totally closed as part of the backwash sequence in order to reduce the backwash flow rate, volume of the sump and size of the sump pump.

An MBR may have multiple membrane tanks in parallel for a given set of biological tanks in series (FIG. 13). Multiple membrane tanks may allow isolation of a subset of the membranes for cleaning or maintenance without disrupting operation of the plant (multiple biological tanks may be used to satisfy biological nutrient removal requirements). There are two options in the design of the submerged overflow screen backwash for such an MBR:
1. Simultaneous backwash. A common overflow pipe from all membrane tanks can be equipped with a single valve to backwash all the immersed screens at the same time. In this situation, the volume of the sump is large.
2. Individual backwash. Overflow pipes from individual tanks can be each equipped with a valve to allow separate backwashing of the screens in each tank. In this situation, the volume of the sump can be made smaller.

The design approach for the submerged backwash will have an impact on the distribution of air to the immersed screens. In the individual backwash, the lowering of the water level in the upstream section of the immersed screens could lead to a significant imbalance in the airflow rate to the screens when all are fed from a unique source (i.e. all the air could be diverted to the tank under backwash, where the static head above the aerators is the lowest). To counter this, one solution is to equip the air supply with a valve to turn off the air to the tank that is backwashed or, alternately, to all of the tanks with screens that are not being backwashed. This is not an issue with the simultaneous backwash.

### Example 1

### Inlet Gates Open

This example is given for a pump-from system as represented by FIG. 12b and FIG. 13.

Average daily flow: 24,000 m3/d

Hydraulic retention time: 8 hours

Calculate total volume of biological tanks: 24,000×8/24=8,000 m³

Average flux: 0.5 m/d (8.94 gfd)

Calculate membrane surface area: 24,000/0.5=48,000 m2

Use ZeeWeed 500d cassettes with surface area of 1680 m2/cassette

Calculate number of cassettes: 48,000/1680=28.5 cassettes

Design system with 6 tanks containing 5 cassettes each.

Membrane tank volume for one cassette: 3 m×3 m×2.5 m: 22.5 m3

Calculate the volume of one membrane tank (membrane section): 22.5×5=112.5 m3

Volume required for immersed screen (per cassette): 3 m×3 m×0.3 m=2.7 m3

Calculate volume for immersed screen per membrane tank: 2.7×5=13.5 m3

Calculate total volume of membrane tank: 112.5+13.5=126 m3

Calculate volume of all membrane tanks: 126×6=756 m3

Calculate volume of anoxic tank: 8,000×1/3=2664 m3

Calculate volume of aerobic tank: 8,000−2664−756=4,580 m3

Assume backwash duration of 30 s

Assume draining 10% volume of the screen section: 13.5×6×0.1=8.1 m3

Assume combined backwash flow rate of 6 Q (5 Q in plus 1 Q backwash): 24,000×6/3,600/24=1.66 m3/s

Calculate total backwash volume: (1.66×30)+8.1=58 m3

Calculate volume of sump as 25% larger: 58×1.25=72.5 m3

Assume 10 backwashes per hour

Calculate sump pump flow rate: 58/6×1440=13,920 m3/d

Calculate fraction of Q: 13,920/24,000=0.58 Q

The volume of the backwash can be significantly reduced by restricting the flow to membrane tanks during a backwash. This can be achieved by closing partly or completely the inlet gate to the membrane tanks prior to initiation of the backwash.

### Example 2

### Inlet Gates Partially Closed

This example is identical to Example 1 with the exception that the inlet gate is partially closed to reduce the inlet flow to 1 Q.

Assume combined backwash flow rate of 2 Q (1 Q in plus 1 Q backwash): 24,000×2/3,600/24=0.55 m3/s

Calculate total backwash volume: (0.55×30)+8.1=24.6 m3

Calculate volume of sump as 25% larger: 24.6×1.25=30.8 m3

Assume 10 backwashes per hour

Calculate sump pump flow rate: 24.6/6×1440=5,904 m3/d

Calculate fraction of Q: 5,904/24,000=0.25 Q

What has been described above is merely to give one or more examples. Other arrangements of elements or steps can be implemented by those skilled in the art, without departing from the scope of the invention, which is defined by the following claims.

We claim:

1. A screening apparatus for use in a water treatment system wherein the one or more screening surfaces are in the shape of three-dimensional bodies having an opening at or near their lower end.

2. The screening apparatus of claim 1 wherein the downstream area is a membrane tank.

3. A screening apparatus according to claim 1 further comprising an outlet for retained screenings from the upstream area.

4. A screening apparatus according to claim 1 wherein the smallest dimension of the openings is 1 mm or less, 100 μm or less or 50 μm or less.

5. A screening apparatus according to claim 1 wherein the three-dimensional bodies have a non-porous section adjacent their openings.

6. A screening apparatus according to claim 1 wherein the upstream area has a volume that is 30% or less of the downstream volume.

7. A screening apparatus according to claim 1 wherein the area of the one or more screening surfaces exceeds the area of the largest vertical cross-section of the screening apparatus by a factor of 2 or more.

8. A screening apparatus according to claim 1 wherein the one or more screening surfaces communicate with one or both of the upstream and downstream areas through a conduit, plenum, header or manifold.

9. A screening apparatus according to claim 1 having an overflow from the upstream area to a waste or recycle stream.

10. A screening apparatus according to claim 1 further comprising a drain from the upstream area.

11. A screening apparatus according to claim 1 having a gas supply connected to one or more aerators, the gas supply configured to provide a gas at a rate that varies between a first rate and a second rate, the second rate being in the range between no flow and about one half of the first rate.

12. An apparatus having a screening apparatus according to claim 1 and further comprising:
a tank having an inlet; and,
a membrane assembly immersed in the tank,
wherein the screening apparatus is located so as to intercept water flowing to the inlet or from the inlet to the membrane assembly.

13. A water treatment system having an apparatus according to claim 12 and a water treatment area upstream of the screening surface.

14. A water treatment system according to claim 13 having a recycle between an upstream side of the screening surface and the water treatment area.

15. A screening apparatus according to claim 1 wherein the opening is at the bottom of the three-dimensional figure.

16. A screening apparatus according to claim 1 wherein the screening surfaces are held in a frame.

17. A screening apparatus according to claim 16 wherein the frame also holds aerators.

18. A screening apparatus according to claim 16 wherein the frame has supporting structures to restrict the movement of upper ends of the screening surfaces.

19. A screening apparatus for use in a water treatment system having an upstream area under ambient pressure with a first static head and a downstream area under ambient pressure with a second static head, the screening apparatus comprising:
one or more generally static screening surfaces in the form of a three-dimensional figure with a discharge port at or near the bottom of the figure and having a plurality of openings, wherein any dimension of the openings is approximately 3 mm or less;
a structure for holding the screening surface in communication with the upstream and downstream areas such that the screening surface intercepts water flowing between the upstream and downstream areas; and,
one or more aerators in communication with the upstream area.

20. An apparatus comprising:
one or more fluidly connected tanks;
an inlet to the one or more tanks;
a membrane assembly immersed in one of the tanks;
a static screen in the form of a three-dimensional figure with a discharge port at or near the bottom of the figure and separating a volume of water containing the membrane assembly from the inlet;
a permeate outlet connected to the membrane assembly; and,
a membrane retentate outlet in communication with the volume of water containing the membrane assembly.

21. A two part screen assembly.

22. A variable length upstream screen section to contain a number of screen assemblies required to meet flow requirements through a static screen.

23. A collector comprising a hollow structural member and optionally discharging horizontally.

24. A collector comprising a pan and optionally discharging vertically.

25. A section of a screen assembly that is solid below an HSM or pan and optionally of smaller diameter.

26. Providing a submerged overflow weir in an upstream section of an immersed screen to facilitate backwashing of the screen.

27. The process of claim 26 used with a pump-from configuration.

28. The process of claim 26 further comprising periodically draining water through the weir to induce a backwash of the screen.

29. The process of claim 28 wherein drained water is sent to an upstream process tank.
